(19) United States
(12) Patent Application Publication
(10) Pub. No.: US 2009/0119609 A1
(43) Pub. Date: May 7, 2009

(54) MEDICAL IMAGE PROCESSING APPARATUS

(75) Inventor: Kazuhiko Matsumoto, Tokyo (JP)

Correspondence Address: PEARNE & GORDON LLP, 1801 EAST 9TH STREET, SUITE 1200, CLEVELAND, OH, 44114-3108, US

(73) Assignee: Ziosoft, Inc., Tokyo (JP)

(21) Appl. No.: 12/263,647

(22) Filed: Nov. 3, 2008

(30) Foreign Application Priority Data
Nov. 6, 2007 (JP) 2007-288451

(51) Int. Cl. G06F 3/048

(52) U.S. Cl. 715/769

(57) ABSTRACT

There is provided a medical image processing apparatus for creating an image according to a parameter and displaying the image on a rendering window. The medical image processing apparatus includes: a cursor control section for detecting whether or not a cursor exists in the rendering window; a icon control section for displaying an icon group near a cursor position in response to a specification operation if the cursor exists in the rendering window, wherein the icon group includes at least two icons and each of the icons represents one- or more-dimensional successive parameters of the image displayed on the rendering window; and a parameter control section for changing the parameters in response to a drag operation when the drag operation is performed with one of the icons as a start point.

This application is based on and claims priority from Japanese Patent Application No. 2007-288451, filed on Nov. 6, 2007, the entire contents of which are hereby incorporated by reference.

### BACKGROUND

1. Technical Field

This present disclosure relates to a medical image processing apparatus that can improve operability at the time of creating an image and displaying the image on a rendering window.

2. Related Art

In recent years, attention has been focused on an art of visualizing the inside of a three-dimensional object with the progression of the image processing technology using a computer. Particularly, medical diagnosis using a Computed Tomography (CT) apparatus or an Magnetic Resonance Imaging (MRI) apparatus capable of visualizing the inside of a living body for finding a lesion at an early stage has been widely conducted in a medical field.

A method called “volume rendering” is known as a method of obtaining a three-dimensional image of the inside of an object. In the volume rendering, virtual ray is applied to a three-dimensional volume space filled with voxel (minute volume element) space, whereby an image is projected onto a projection plane. As a kind of this operation, a raycast method is available. In the raycast method, voxel values are sampled at given intervals along the ray path and the voxel values are acquired from the voxel at each sampling point.

The voxel is an element unit of a three-dimensional region of an object and the voxel values are unique data representing the characteristic of the density value of the voxel. The whole object is represented by voxel data of a three-dimensional array of the voxel values. Usually, two-dimensional tomographic image data obtained by CT is stacked in a direction perpendicular to the tomographic plane and necessary interpolation is performed, whereby voxel data of a three-dimensional array are obtained.

In the raycast method, it is assumed that viral reflected light for a virtual ray applied from a virtual eye to an object is produced in response to the opacity artificially set for the voxel values. To capture a virtual surface, the gradient of voxel data, namely, a normal vector is found and a shading coefficient for shading is calculated from the cosine of the angle between the virtual ray and the normal vector. The virtual reflected light is calculated by multiplying the strength of the virtual ray applied to the voxel by the opacity of the voxel and the shading coefficient.

FIG. 11 is a drawing to describe a rendering window and icons. In FIG. 11, a three-dimensional image of a heart created from volume data is displayed on a rendering window 11. An Icon group containing an image rotation icon 13, an image parallel move icon 14, an image scaling icon 15, and a window width (WW)/window level (WL) transfer icon 16 is displayed around the rendering window 11.

The user can change the operation type by clicking the image rotation icon 13, the image parallel move icon 14, the image scaling icon 15, or the WW/WL transfer icon 16 and can perform operation corresponding to the clicked icon 13, 14, 15, or 16 by dragging a cursor 12 on the image from position “a” to position “f”.

The icons 13 to 16 corresponding to the operation types are thus displayed on around the rendering window 11. Whenever changing the operation type, the user needs to frequently move his eye line to the icons 13 to 16 from the rendering window 11 so as to move the cursor. For example, upon finding a lesion while viewing a medical image, the doctor frequently rotates, moves, or scales up or down the image thus to frequently moves his eye line between the image and the icon. Thus, the doctor may lose sight of the lesion, which is slightly different in shadow and color, in the medical image.

Thus, this leads to an increase in fatigue of the user and thus degradation of the diagnosis quality such as occurrence of oversight may occur. In changing the operation type, a user interface (UI) using a shift key of a keyboard is not appropriate in such a medical image processing apparatus that a large number of image types exist and the possible operation type varies depending on one image type.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the problems described above.

Accordingly, it is an aspect of exemplary embodiments of the present invention to provide a medical image processing apparatus that enables the user to switch the operation type as movement of his eye line is lessened.

According to one or more aspects of the present invention, there is provided a medical image processing apparatus for creating an image according to a parameter and displaying the image on a rendering window. The medical image processing apparatus includes: a cursor control section for detecting whether or not a cursor exists in the rendering window; a icon control section for displaying an icon group near a cursor position in response to a specification operation if the cursor exists in the rendering window, wherein the icon group includes at least two icons and each of the icons represents one- or more-dimensional successive parameters of the image displayed on the rendering window; and a parameter control section for changing the parameters in response to a drag operation when the drag operation is performed with one of the icons as a start point.

According to one or more aspects of the present invention, the medical image processing apparatus further includes: a touch panel for displaying the icons and accepting the drag operation of any of the icons.

According to one or more aspects of the present invention, after completion of the drag operation, the cursor control section restores the cursor position to a position of the rendering window at the time of starting the drag operation.

According to one or more aspects of the present invention, after completion of the drag operation, the cursor control section moves the cursor position to a position corresponding to a point on the image at the time of starting the drag operation.

According to one or more aspects of the present invention, the parameter control section assigns parameter operations different from each other to the icon, the parameter operations corresponding to two degrees of freedom of the drag operation.

According to one or more aspects of the present invention, when one of the icons is operated, predetermined processing is started.

According to one or more aspects of the present invention, the parameters are two- or more-dimensional successive parameters. When the drag operation is performed with the icon as the start point, the parameter control section select one-successive parameters from the two- or more-dimensional successive parameters according to a cursor move direction at the time of starting the drag operation.

According to one or more aspects of the present invention, the parameter control section selects the one- or more-dimensional successive parameters when one of the icons is selected. The parameter control section changes the selected one- or more-dimensional successive parameters in response to the drag operation when the drag operation is performed with the rendering window as the start point.

According to one or more aspects of the present invention, the medical image processing apparatus further includes: an image processing section for generating the image on the rendering window from volume data, and the icon control section determines the icon group to be displayed in response to the type of image displayed on the rendering window.

According to one or more aspects of the present invention, the icon group is displayed at a predetermined relative position to the cursor position.

According to one or more aspects of the present invention, there is provided a computer readable medium having a program including instructions for permitting a computer to create an image according to a parameter and display the image on a rendering window. The instructions includes: detecting whether or not a cursor exists in the rendering window; displaying an icon group near a cursor position in response to a specification operation if the cursor exists in the rendering window, wherein the icon group includes at least two icons and each of the icons represents one- or more-dimensional successive parameters of the image displayed on the rendering window; and changing the parameters in response to a drag operation when the drag operation is performed with one of the icons as a start point.

According to the present invention, the icon group appears near the cursor, so that when the user performs drag operation with any of the icons as the start point the user need not avert his eye line from the image and thus can perform quick operation. Further, the user can memorize the display positions of the icons sensibly and can perform operation precisely at high speed. Further, a different icon group is displayed in response to the type of image to be displayed, so that the user can perform operation according to the image type quickly and can conduct image diagnosis smoothly. Further, the operation type is determined according to the cursor move direction at the start time of drag operation, so that the user can focus on operating the image without paying attention to the drag direction and can conduct smooth image diagnosis.

Other aspects and advantages of the present invention will be apparent from the following description, the drawings, and the claims.

### BRIEF DESCRIPTION OF THE DRAWINGS

In the accompanying drawings:

FIG. 1 is a schematic view illustrating a computed tomography (CT) apparatus and a medical image processing apparatus according to an exemplary embodiment of the present invention;

FIG. 2 is a flowchart to describe an operation of the medical image processing apparatus according to the exemplary embodiment of the present invention;

FIG. 3A is a view illustrating an example of a rendering window 11 in the medical image processing apparatus according to the exemplary embodiment of the present invention;

FIG. 3B is a view illustrating another example of the rendering window 11 in the medical image processing apparatus according to the exemplary embodiment of the present invention;

FIG. 4 is a view illustrating a state that a cursor position is automatically restored after drag operation in Example 1;

FIGS. 5A and 5 are views illustrating a state that a cursor is caused to follow the image being operated in Example 2;

FIG. 6 is a view illustrating a state that one icon is associated with two operation types in Example 3;

FIGS. 7A and 7B are schematic views illustrating a state that a different icon group is displayed in response to the type of image to be displayed in Example 4;

FIG. 8 is a schematic view illustrating a state that the operation type is determined according to motion of a cursor at the drag start time in Example 5;

FIG. 9 is a schematic view illustrating a state that an operation mode is switched by double-clicking an icon in Example 6;

FIG. 10 is a view to describe technical terms used in the present specification; and

FIG. 11 is a drawing to describe a rendering window and icons.

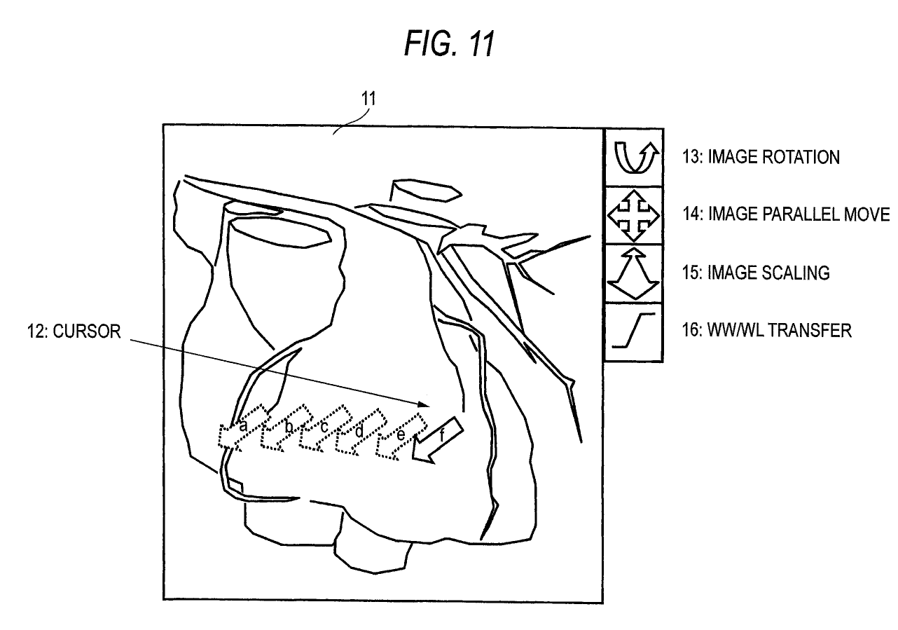

### DETAILED DESCRIPTION OF EXEMPLARY EMBODIMENTS

Exemplary embodiments of the present invention will be described with the drawings hereinafter.

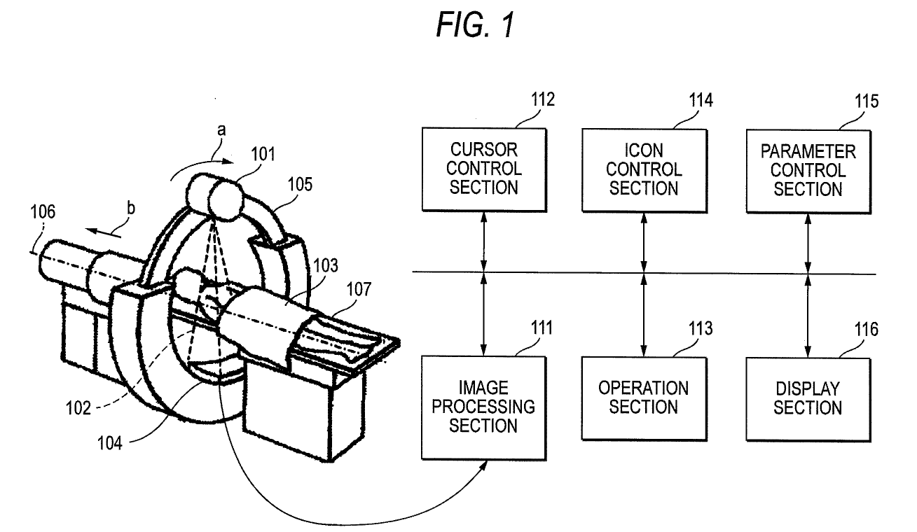

FIG. 1 is a schematic view illustrating a medical image processing apparatus according to an exemplary embodiment of the present invention and a computed tomography (CT) apparatus. The computed tomography apparatus is used for visualizing the tissue of a specimen. An X-ray beam bundle 102 shaped like a pyramid (indicated by the chain line) is radiated from an X-ray source 101. The X-ray beam bundle 102 passes through a patient 103 as a specimen and is detected by an X-ray detector 104. In the present embodiment, the X-ray source 101 and the X-ray detector 104 are arranged on a ring-like gantry 105 to oppose to each other. The ring-like gantry 105 is supported by a retainer (not shown in the figure) so as to rotate (see arrow a) around a system axis 106 passing through the center point of the gantry 105.

In the present embodiment, the patient 103 lies down on a table 107 through which an X-ray passes. The table is supported by the retainer (not shown) so as to move along the system axis 106 (see arrow “b”).

Therefore, the X-ray source 101 and the X-ray detector 104 can rotate around the system axis 106 and also can move relatively to the patient 103 along the system axis 106. Therefore, the patient 103 can be projected at various projection angles and at various positions relative to the system axis 106. An output signal of the X-ray detector 104 generated at the time is supplied to an image processing section 111, and then converts the signal into volume data.

In a sequence scanning, scanning is executed for each layer of the patient 103. Then, the X-ray source 101 and the X-ray detector 104 rotate around the patient 103 with the system axis 106 as the center, and the measurement system including the X-ray source 101 and the X-ray detector 104 photographs a large number of projections to scan two-dimensional tomograms of the patient 103. A tomographic image for displaying the scanned tomogram is reconstructed based on the acquired measurement values. The patient 103 is moved along the system axis 106 each time in scanning successive tomograms. This process is repeated until all tomograms of interest are captured.

On the other hand, in spiral scanning, the measurement system including the X-ray source 101 and the X-ray detector 104 rotates around the system axis 106 while the table 107 moves continuously in the direction of the arrow “b”. That is, the measurement system including the X-ray source 101 and the X-ray detector 104 moves continuously on the spiral orbit relative to the patient 103 until all regions of interest of the patient 103 are captured. In the embodiment, a large number of successive tomographic signals in the diagnosis range of the patient 103 are supplied to the image processing section 111 by the computed tomography apparatus shown in the figure.

A cursor control section 112 controls the position of a cursor displayed in an image and detects whether or not a cursor exists in the area (a rendering window area) of a rendering window for displaying an image. If the cursor exists in the rendering window area, an icon control section 114 displays an icon group near the cursor position in response to specification operation of the user by click operation. The icon group includes at least two icons and each of the icons represents one- or more-dimensional successive parameters of an image displayed on the rendering window. The expression “one- or more-dimensional successive parameters” mentioned above means one-or-more-scalar real or integer number. Also, the expression “near the cursor position” mentioned above means a predetermined position relative to the cursor position and the peripheral area of the cursor position that can be visually recognized when the user pays attention to the cursor position.

When the user performs drag operation with an icon displayed in the rendering window area as the start point a parameter control section 115 changes one- or more-dimensional successive parameters associated with the icon in response to the drag operation. The expression “when the user performs drag operation with an icon displayed in the rendering window area as the start point” means that the start position of drag operation exists in the icon display area. Also, the expression “change parameters in response to the drag operation” means that parameters are changed in response to the operation direction, the operation amount, the operation time, and the acceleration of the drag operation. The image processing section 111 generates volume data from tomographic signals and creates an image displayed on a display section 116.

An operation section 113 includes a Graphical User Interface (GUI), and sets the rendering window in response to an operation signal from a keyboard, a pointing device (a mouse or a track ball). Then, the operation section 113 generates a control signal of a setup value, and then supplies the control signal to the cursor control section 112, the icon control section 114, and the parameter control section 115. Accordingly, the user can change the image interactively while viewing the image on the display section 116, and thus can find a lesion.

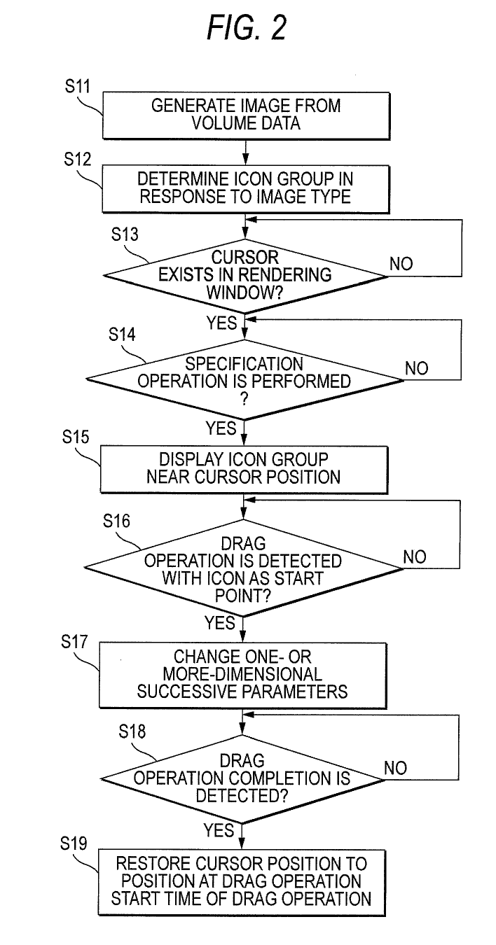

FIG. 2 is a flowchart to describe a medical image processing method according to the exemplary embodiment of the present invention. Firstly, the image processing section 111 generates an image displayed on a rendering window based on volume data supplied from the CT apparatus (step S11). The icon control section 114 determines the icon group to be displayed in response to the type of image displayed on the rendering window (step S12).

Next the cursor control section 112 determines whether or not a cursor exists in the rendering window area (step S13). If a cursor exists in the rendering window area (YES), whether or not the user performs specification operation (for example, click operation on image) is determined (step S14).

If the user performs specification operation (YES), the icon control section 114 displays an icon group, which includes at least two or more icons each representing one- or more-dimensional successive parameters of the image displayed on the rendering window, near the cursor position in response to the user's operation (step S15).

Next, the parameter control section 115 determines whether or not the user has performed drag operation with an icon as the start point (step S16). If the user has performed drag operation with an icon as the start point (YES), the parameter control section 115 changes one- or more-dimensional successive parameters associated with the type of icon selected as the start point (step S17).

Next, the cursor control section 112 determines whether or not the drag operation has been completed (step S18). If it is detected that drag operation of the icon selected as the start point is completed (YES), the cursor control section 112 restores the cursor position to the position of the rendering window at drag operation start time (step S19). In this case, after completing the drag operation for the icon selected as the start time of the drag operation, the cursor position can also be moved to the position corresponding to a point on the image at the start time of the drag operation.

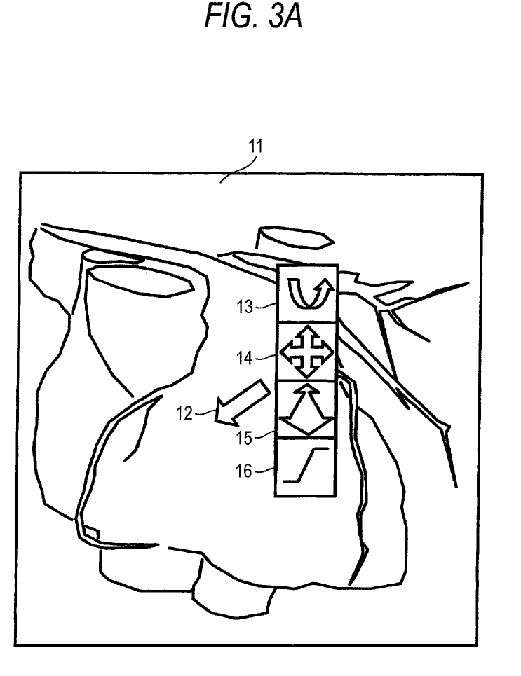

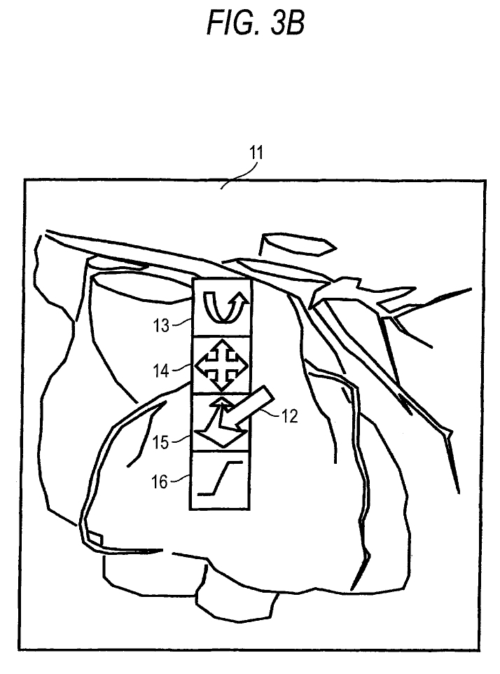

FIGS. 3A and 3B show examples of the rendering window 11 in the medical image processing apparatus according to the exemplary embodiment of the present invention. If the user clicks on the rendering window 11, the icon group (icons 13 to 16) for representing the operation type for the image appears near a cursor 12, as shown in FIG. 3A. FIG. 3B shows an example that the icon group (icons 13 to 16) is displayed at the position of the cursor 12. As shown in FIG. 3B, the expression “near the cursor 12” contains the position where the distance from the position of the cursor 12 is 0. The user performs drag operation with the icon 13, 14, 15, or 16 as the start point, whereby an image operation corresponding to one of the icon 13, 14, 15, or 16 is performed. The position where the icon group (the icons 13 to 16) appears is determined by the relative positions to the cursor 12. Accordingly, the user can feel the positions of the icons as touch type.

In the medical image processing apparatus according to the exemplary embodiment of the present invention, the icon group (the icons 13 to 16) appears near the cursor 12, so that when the user performs drag operation for operating an image with any of the icons 13 to 16 displayed near the cursor 12 as the start point the user need not avert his eye line from the image and thus can perform quick operation. Further, the user can memorize the display positions of the icons 13 to 16 sensibly and thus can perform operation precisely at high speed.

### Example 1

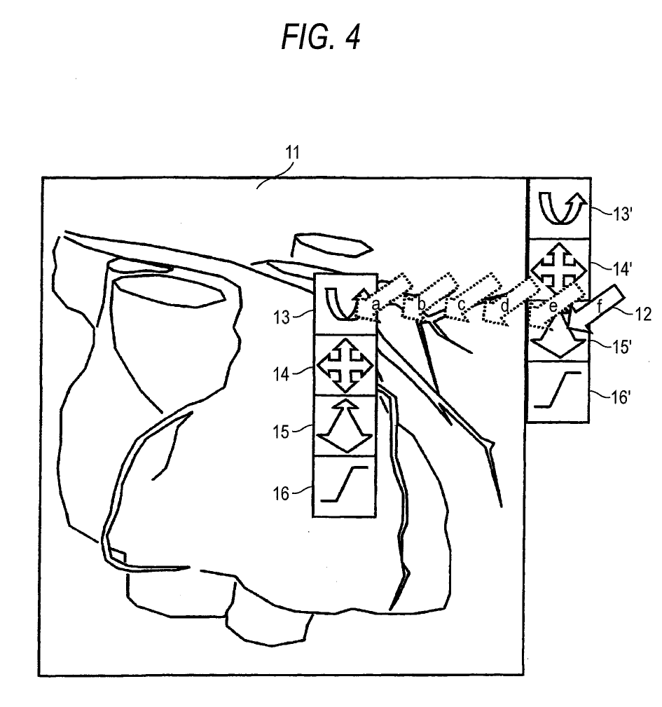

FIG. 4 is a view illustrating a state that the cursor position is automatically restored after drag operation in the medical image processing apparatus according to the exemplary embodiment of the present invention. Firstly, when rotating an image, the user sets the cursor 12 onto the image rotation icon 13 displayed on the rendering window 11 and then performs drag operation of the cursor 12 from position “a” to position “f” while pressing a button of the pointing device. Thus, the image displayed on the rendering window 11 can be rotated.

Thus, in the medical image processing apparatus according to the exemplary embodiment, the icon group (the icons 13 to 16) is displayed near the position of interest on the image (the cursor position), so that the user can perform operation of image rotation without averting his eye line from the region of interest. Since the user can perform image rotation by drag operation of one operation using the pointing device, the burden of the user's operation can be reduced.

Meanwhile, in the medical image processing apparatus according to the exemplary embodiment, after the cursor 12 is dragged from position “a” to position “f” and image rotation operation is performed, the cursor is automatically restored to the position “a”. Accordingly, the user can immediately start any other operation such as image scaling. Further, movement of the eye line for locating the cursor 12 after image operation can be eliminated. Particularly, if the cursor 12 moves outside the rendering window 11 (position f) by drag operation, it is not necessary to manually restore the cursor to the rendering window after the drag operation. The cursor 12 may be hidden during the drag operation. This can prevent interrupting the operation when the cursor 12 reaches an end of the screen by the drag operation. Thus, only move operation for the pointing device may be detected without moving the cursor on implementation. The icon group (the icons 13 to 16) may be hidden. This enables the user to concentrate on the image.

### Example 2

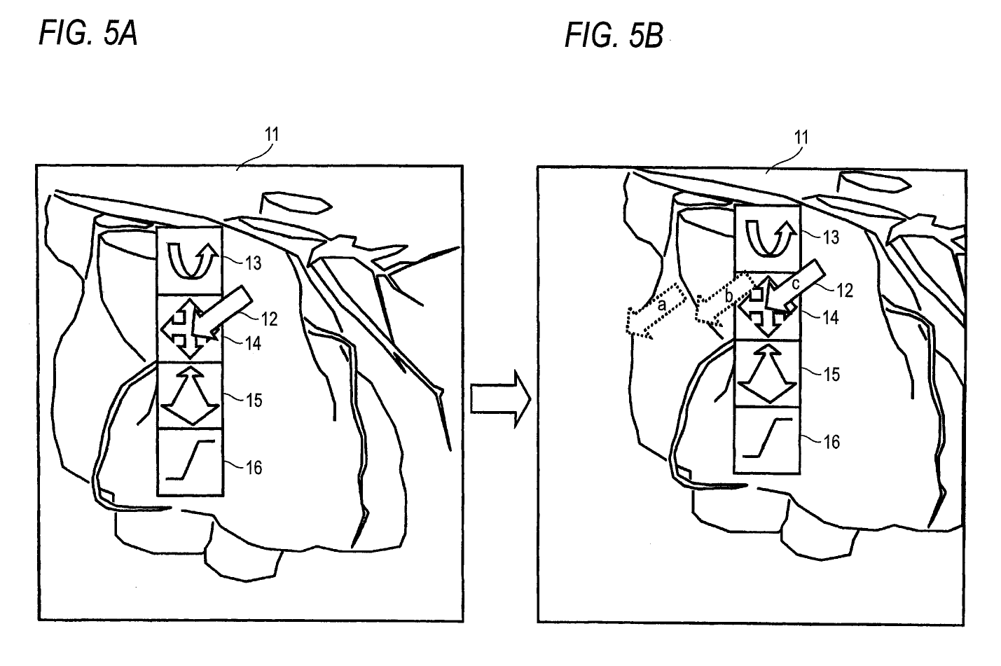

FIGS. 5A and 5B are views illustrating a state that the cursor 12 is caused to follow the image being operated in the medical image processing apparatus according to the exemplary embodiment of the present invention. FIG. 5A shows a state that the user sets the cursor 12 onto the image parallel move icon 14 to perform a parallel move of an image. The user press the button of the pointing device on the image parallel move icon 14 and then drag to the right while pressing the button, thereby performing the parallel move of the image to the right.

FIG. 5B shows a state that the cursor 12 is dragged from position “a” to position “c” and thus a parallel move of an image is performed. In the exemplary embodiment, if the drag operation is terminated at the position “c”, the cursor 12 is left at the position “c”. Thus, according to the exemplary embodiment, particularly when parallel move or scaling operation is performed, the cursor position is caused to follow the point on the image after the operation. This can prevent movement of the eye line for locating the cursor 12 after the image operation. At this time, the icon group (the icons 13 to 16) is also caused to follow the image after the image operation, whereby the distance for moving the cursor 12 for the next operation is shortened and thus the user can perform the next operation quickly.

### Example 3

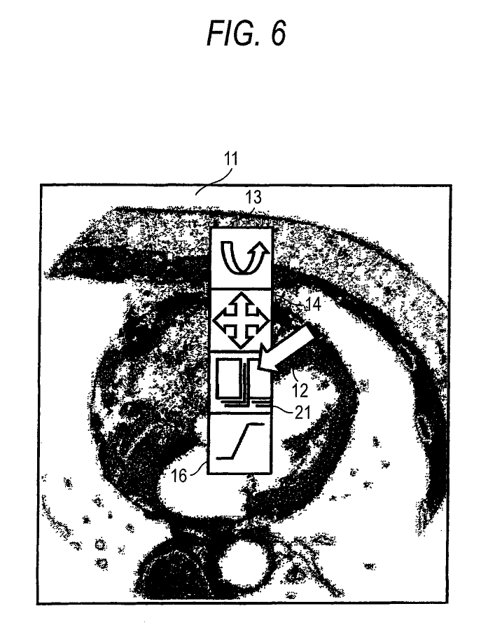

FIG. 6 is a view illustrating a state that one icon is associated with two operation types in the medical image processing apparatus according to the exemplary embodiment of the present invention. Since drag operation involves two degrees of freedom (up/down and right/left), one icon may be associated with operation types different in concept such as “up/down slice display” and “preceding/following on time series.” Some processing such as “menu display”, etc., may be started in response to simple click operation rather than drag.

FIG. 6 shows a state that a slice/time series icon 21 is displayed in the icon group and the user sets the cursor 12 to the slice/time series icon 21. In this case, when the user presses the button of the pointing device on the slice/time series icon 21 and drags up or down, a slice image different in slice position can be displayed. Meanwhile, when the user presses the button of the pointing device on the slice/time series icon 21 and drags to the right or the left, an image on the time series can be displayed.

Thus, according to the medical image processing apparatus according to the exemplary embodiment, one icon is associated with two operation types, so that the number of the displayed icons can be decreased and a large number of operation types can be assigned to the icons. Since two operation types can be performed by pressing the button of the pointing device once or performing successive drag operation, operation can be performed quickly.

### Example 4

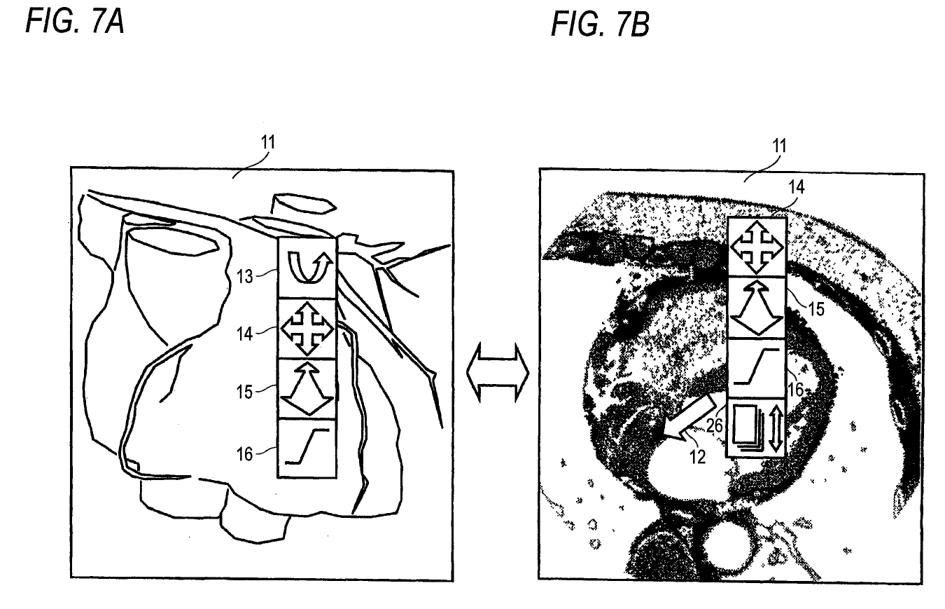

FIGS. 7A and 7B are schematic views illustrating a state that a different icon group is displayed in response to the type of image to be displayed in the medical image processing apparatus according to the exemplary embodiment of the present invention. In the exemplary embodiment, the displayed icons vary depending on the image type (volume data visualization means) on the rendering window where the cursor exists.

FIG. 7A shows an icon group when a three-dimensional image is displayed on the rendering window 11. In this case, the icon group contains the image rotation icon 13, the image parallel move icon 14, the image scaling icon 15, and the window width (WW)/window level (WL) transfer icon 16.

The WW/WL value is a parameter used for adjusting the contrast and the brightness of display in a gray scale image (including such as a Maximum Intensity Projection MIP image). For example, when the gray scale value is given as 4096 gray levels, the operation of cutting out the range particularly effective for diagnosis and converting into 256 gray levels is referred to as WW/WL transfer and the width of the cutout range and the center value of the cutout range are referred to as window width (WW) and window level (WL), respectively.

FIG. 7B shows an icon group when a slice image is displayed on the rendering window 11. In this case, the icon group contains the image parallel move icon 14, the image scaling icon 15, the WW/WL transfer icon 16, and a slice change icon 26. According to the exemplary embodiment, a different icon group is displayed depending on the type of image to be displayed, so that operation responsive to the image type can be performed quickly and image diagnosis can be conducted smoothly.

Also, the image types and the icons can be associated with each other as listed in Table 1.

TABLE 1

| Image type | Icons |
|---|---|
| Simple slice | Parallel move; scaling; up and down slice display; |
| | WW/WL transfer |
| Multi Planer | Rotation; parallel move; scaling; up and down move; |
| Reformation | WW/WL transfer |
| (MPR) | |
| Curved Planer | Rotation about path; parallel move; scaling; up and |
| Reconstruction | down move; WW/WL transfer |
| (CPR) | |
| Maximum | Rotation; parallel move; scaling; WW/WL transfer |
| Intensity | |
| Projection | |
| (MIP) | |
| Raycast | Rotation; parallel move; scaling; LUT function change |
| 4D (dimension) | Preceding and following on time series, in addition |
| | to the above-mentioned operations |
| Fusion | Adjustment of position relationship among a plurality |
| | of volume data, in addition to the above-mentioned |
| | operations |
| Angiography | Preceding and following on time series; display as |
| | moving Image, in addition to planar operation |
| Miscellaneous | Various types of operations for mask creation |

### Example 5

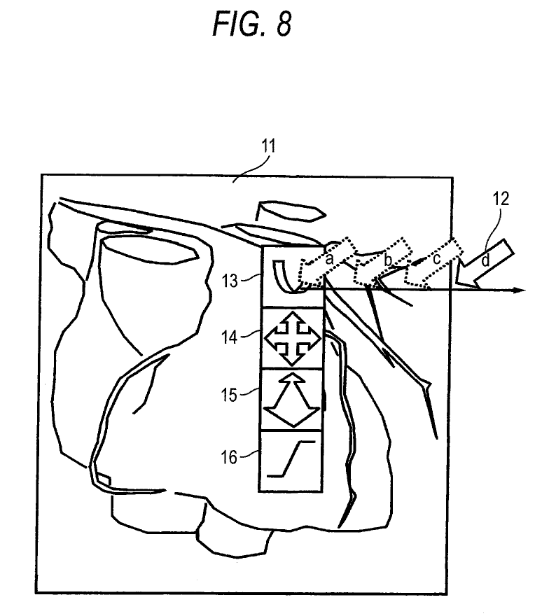

FIG. 8 is a schematic view illustrating a state that the operation type is determined according to motion of a cursor at the drag start time in the medical image processing apparatus according to the exemplary embodiment of the present invention. In the exemplary embodiment, the operation type is determined according to the cursor move direction at the start time of the drag operation. That is, in the exemplary embodiment, an icon represents two- or more-dimensional successive parameters and if the user performs drag operation with the icon as the start point, the parameter control section further determines the one- or more-dimensional successive parameters from the two- or more-dimensional successive parameters according to the cursor move direction at the start time of the drag operation. For example, if the cursor moves to the left or the right at the drag start time, the operation is determined horizontal rotation. If the cursor moves up and down at the drag start time, the operation is determined vertical rotation. If the cursor moves in a slanting direction at the drag start time, the operation is determined free rotation. Accordingly, the operation type can be determined by intuitive operation, and thus the operation can be facilitated.

FIG. 8 shows a state that icons containing e.g., the image rotation icon 13 are displayed on the rendering window 11. The user sets the cursor 12 to the image rotation icon 13, presses the button of the pointing device, and then drags the cursor to the right (position “a” to “d”), so that the image can be horizontally rotated. According to the exemplary embodiment, the operation type is determined according to the cursor move direction at the start time of the drag operation and thus even if the drag direction slightly shifts in a slanting direction during the operation, the horizontal rotation of the image can be performed. Therefore, processing as desired by the user is determined, whereby the user can focus on operating the image without paying attention to the drag direction and thus can conduct smooth image diagnosis.

### Example 6

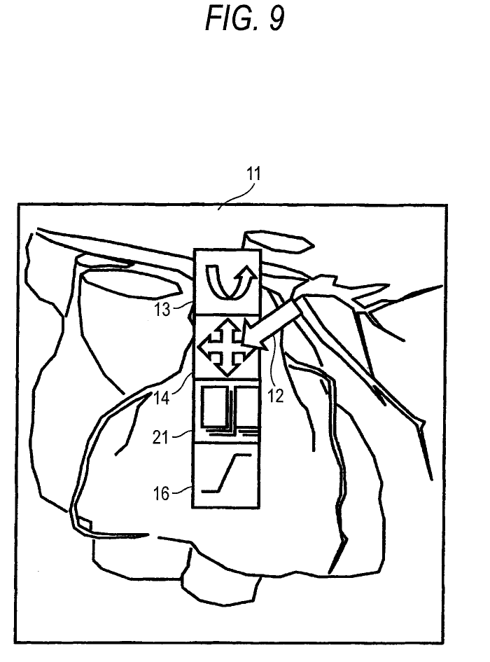

FIG. 9 is a schematic view illustrating a state that an operation mode is switched by double-clicking an icon in the medical image processing apparatus according to the exemplary embodiment of the present invention. In the exemplary embodiment, after the operation type is switched by double-clicking an icon, even if the user repeats drag operation as desired in the rendering window, processing conforming to the operation type is performed. Accordingly, high convenience is provided when it is not necessary to change the operation type frequently, etc.

FIG. 9 shows a state that icons such as the image rotation icon 13 are displayed on the rendering window 11. The user sets the cursor 12 to the image parallel move icon 14 and double-clicks the icon, whereby an image parallel move mode can be set. According to the exemplary embodiment, after the image parallel move mode is once set by double-clicking, it is made possible to perform processing conforming to the mode and high convenience is provided. Particularly, after a mode is set by double-clicking, when an icon group is displayed and the mode is reset whereby the convenience improves still more. When mode change is performed, if the cursor is changed to a cursor for representing the mode, good usability is provided. The mode can be set for each rendering window.

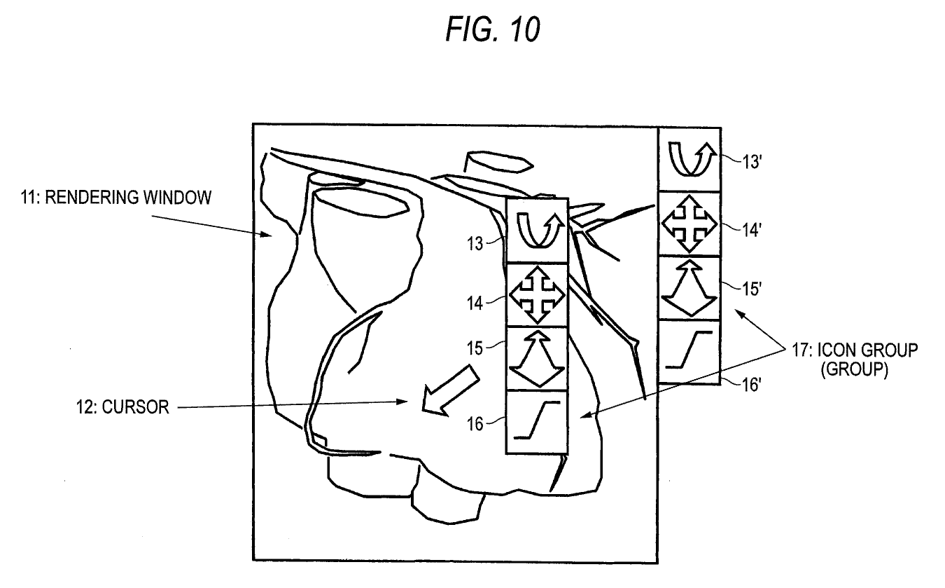

FIG. 10 is a drawing to describe technical terms used in the present specification. The rendering window 11 is a window on which the rendering result of volume rendering is displayed. Icons 13 to 16 and 13′ to 16′ display illustrations or illustrations paired with characters to which some commands are assigned. An icon group 17 indicates a group of icons that can be operated in response to the image type. The “operation type” represents the type of successive parameters or successive parameter combinations for determining the condition of rendering that can be operated, and the “operation” represents an operation performed by the user. The “successive parameters” represents parameters representing discrete values for convenience of information processing although the parameters are essentially successive like rotation angle, coordinates, time, contrast value, etc. The slice image number represents slice image positions, and thus is contained in “successive parameters.”

In the description given above, it is assumed that an icon group is preset and is displayed in response to the image type, but the user can also customize the types of icons to be displayed, the icon display locations, etc., in the icon group. An icon group may be previously displayed outside a rendering window. The icons may include an icon for accepting operation not involved in drag operation such as command start.

In the description given above, the user performs operation by drag operation with an icon as the start point, but may perform rotation operation of a wheel while setting the pointing device to an icon. Accordingly, the user can operate through three degrees of freedom in addition to two degrees of freedom of up/down and right/left move of the pointing device, so that the user can easily perform operation for a three-dimensional image.

In the description given above, the icon group is displayed near the cursor position in response to user operation, but the cursor position at the time may be used for later operation. For example, when scaling operation is performed, the cursor position can be used as the center of scaling. For example, when rotation operation is performed, the positions on an object projected from the cursor position to volume data (positions provided in point pick processing) can be used as the rotation center.

The medical image processing apparatus of the exemplary embodiment can also be provided with a touch panel for displaying icons and accepting drag operation of any of the icons as operation display section. The touch panel has no moving part and can be easily disinfected and sterilized, etc., and thus is appropriate for use at the operating site.

An icon group may be displayed in any way other than click. For example, keyboard operation, voice input device operation, and dedicated switch operation are possible.

Thus, according to the medical image processing apparatus according to the exemplary embodiment, the icon group is displayed near the position of interest on the image (the cursor position), so that the user can perform operation of image rotation without averting his eye line from the region of interest. Since the user can perform image rotation by drag operation following one pressing the button of the pointing device, the burden of the user's operation can be reduced. The present invention is particularly effective when the user performs operation while switching the operation type one after another.

While there has been described in connection with the exemplary embodiments of the present invention, it will be obvious to those skilled in the art that various changes and modification may be made therein without departing from the present invention. It is aimed, therefore, to cover in the appended claim all such changes and modifications as fall within the true spirit and scope of the present invention.

What is claimed is:

1. A medical image processing apparatus for creating an image according to a parameter and displaying the image on a rendering window, the medical image processing apparatus comprising:
a cursor control section for detecting whether or not a cursor exists in the rendering window,
a icon control section for displaying an icon group near a cursor position in response to a specification operation if the cursor exists in the rendering window, wherein the icon group includes at least two icons and each of the icons represents one- or more-dimensional successive parameters of the image displayed on the rendering window; and
a parameter control section for changing the parameters in response to a drag operation when the drag operation is performed with one of the icons as a start point.

2. The medical image processing apparatus of claim 1, further comprising:
a touch panel for displaying the icons and accepting the drag operation of any of the icons.

3. The medical image processing apparatus of claim 1, wherein after completion of the drag operation, the cursor control section restores the cursor position to a position of the rendering window at the time of starting the drag operation.

4. The medical image processing apparatus of claim 1, wherein after completion of the drag operation, the cursor control section moves the cursor position to a position corresponding to a point on the image at the time of staring the drag operation.

5. The medical image processing apparatus of claim 1, wherein the parameter control section assigns parameter operations different from each other to the icon, the parameter operations corresponding to two degrees of freedom of the drag operation.

6. The medical image processing apparatus of claim 1, wherein when one of the icons is operated, predetermined processing is started.

7. The medical image processing apparatus of claim 1, wherein the parameters are two or more-dimensional successive parameters, and wherein
when the drag operation is performed with the icon as the start point, the parameter control section select one-successive parameters from the two- or more-dimensional successive parameters according to a cursor move direction at the time of starting the drag operation.

8. The medical image processing apparatus of claim 1, wherein the parameter control section selects the one- or more-dimensional successive parameters when one of the icons is selected, and
wherein the parameter control section changes the selected one- or more-dimensional successive parameters in response to the drag operation when the drag operation is performed with the rendering window as the start point.

9. The medical image processing apparatus of claim 1, further comprising:
an image processing section for generating the image on the rendering window from volume data, and
wherein the icon control section determines the icon group to be displayed in response to the type of image displayed on the rendering window.

10. The medical image processing apparatus of claim 1, wherein the icon group is displayed at a predetermined relative position to the cursor position.

11. A computer readable medium having a program including instructions for permitting a computer to create an image according to a parameter and display the image on a rendering window, the instructions comprising:
detecting whether or not a cursor exists in the rendering window;
displaying an icon group near a cursor position in response to a specification operation if the cursor exists in the rendering window, wherein the icon group includes at least two icons and each of the icons represents one- or more-dimensional successive parameters of the image displayed on the rendering window, and
changing the parameters in response to a drag operation when the drag operation is performed with one of the icons as a start point.
